(19) United States
(12) Patent Application Publication
(10) Pub. No.: US 2007/0069807 A1
(43) Pub. Date: Mar. 29, 2007

(54) Voltage regulation having varying reference during operation

(75) Inventor: Yick Yaw Ho, Melaka (MY)

Correspondence Address: INTEL/BLAKELY, 12400 WILSHIRE BOULEVARD, SEVENTH FLOOR, LOS ANGELES, CA, 90025-1030, US

(73) Assignee: INTEL CORPORATION

(21) Appl. No.: 11/523,117

(22) Filed: Sep. 18, 2006

(30) Foreign Application Priority Data
Sep. 23, 2005 (MY) PI 20054480

(51) Int. Cl. G05F 1/10

(52) U.S. Cl. 327/541

(57) ABSTRACT

For one disclosed embodiment, a reference voltage signal is generated. Error in an output voltage signal at an output node is sensed based on the reference voltage signal. The output voltage signal is controlled based on the sensed error. The reference voltage signal is varied as the output voltage signal is controlled. Other embodiments are also disclosed.

### FIELD

Embodiments described herein generally relate to voltage regulation.

### BACKGROUND

Voltage regulators may be used, for example, to provide different supply voltage signals to different portions of an integrated circuit. A voltage regulator may, for example, receive a supply voltage signal from a power supply external to the integrated circuit and convert the supply voltage signal into a lower supply voltage signal for use by a portion of the integrated circuit. Designing portions of an integrated circuit to operate using lower supply voltage signals helps reduce power consumption of the integrated circuit.

One prior voltage regulator switches between two voltage generators to supply a supply voltage signal for different operating modes for the integrated circuit. Switching between voltage generators, however, may cause voltage droop in the supply voltage signal. If the voltage falls below a reset level, circuits being supplied with the supply voltage signal may be corrupted.

### BRIEF DESCRIPTION OF THE DRAWINGS

Embodiments are illustrated by way of example and not limitation in the figures of the accompanying drawings, in which like references indicate similar elements and in which:

FIG. 1 illustrates, for one embodiment, a block diagram of an integrated circuit comprising a voltage regulator having a varying reference during operation;

FIG. 2 illustrates, for one embodiment, a flow diagram to regulate a voltage signal using a varying reference during operation;

FIG. 3 illustrates, for one embodiment, example circuitry to implement the voltage regulator of FIG. 1;

FIG. 4 illustrates, for one embodiment, an example signal timing diagram for circuitry of FIG. 3; and

FIG. 5 illustrates, for one embodiment, an example system comprising a chipset having a voltage regulator having a varying reference during operation.

The figures of the drawings are not necessarily drawn to scale.

### DETAILED DESCRIPTION

The following detailed description sets forth example embodiments of methods, apparatuses, and systems relating to voltage regulation having a varying reference during operation. Features, such as structure(s), function(s), and/or characteristic(s) for example, are described with reference to one embodiment as a matter of convenience; various embodiments may be implemented with any suitable one or more described features.

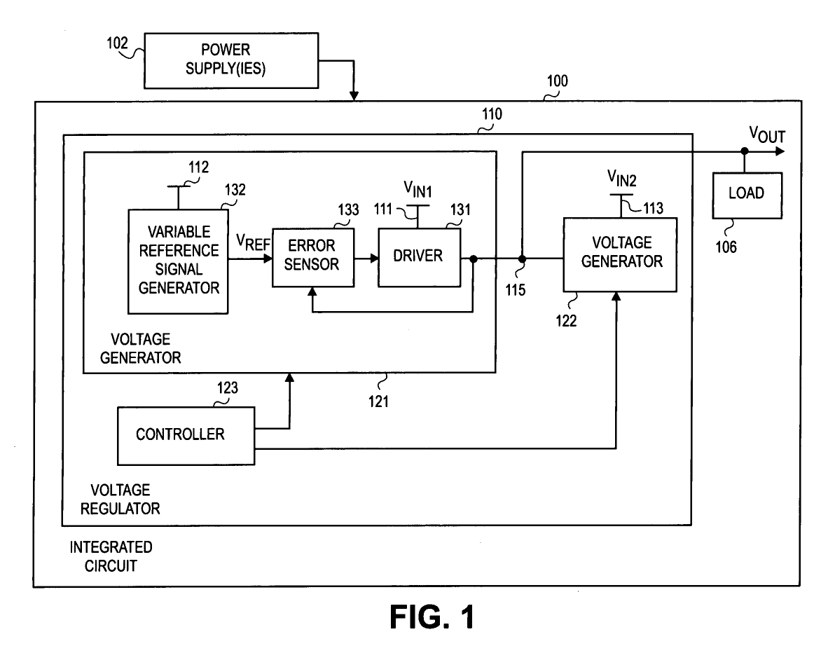

FIG. 1 illustrates, for one embodiment, an integrated circuit 100 having a voltage regulator 110 having a varying reference during operation. Voltage regulator 110 may be coupled to receive an input supply voltage V_{IN1} signal at a supply node 111 and supply a regulated output supply voltage V_{OUT} signal at an output node 115 to one or more circuits, represented by a load 106, of integrated circuit 100. Although described in connection with regulating a supply voltage signal, voltage regulator 110 may be used to help regulate any suitable output voltage signal.

Integrated circuit 100 for one embodiment may be coupled to one or more external power supplies 102 to generate the input supply voltage V_{IN1} signal at supply node 111. Power supply(ies) 102 for one embodiment may comprise a battery. Power supply(ies) 102 for one embodiment may comprise an alternating current to direct current (AC-DC) converter. Power supply(ies) 102 for one embodiment may comprise a DC-DC converter.

Voltage regulator 110 for one embodiment may supply a regulated output supply voltage V_{OUT} signal at output node 115 based on a reference signal to help maintain the output supply voltage V_{OUT} signal at output node 115 despite the circuit(s) of load 106 drawing varying amounts of current from and/or supplying varying amounts of current to voltage regulator 110. Voltage regulator 110 for one embodiment may help supply a regulated output supply voltage V_{OUT} signal substantially equal to the reference signal.

Voltage regulator 110 for one embodiment may vary the reference signal during operation of voltage regulator 110, that is as voltage regulator 110 outputs the output supply voltage V_{OUT} signal at output node 115, to help control the output supply voltage V_{OUT} signal. Voltage regulator 110 for one embodiment may vary the reference signal in any suitable manner for any suitable purpose. Voltage regulator 110 for one embodiment may vary the reference signal to help prevent or reduce voltage droop at output node 115. Voltage regulator 110 for one embodiment may vary the reference signal to help provide an initial boost in supplying the output supply voltage V_{OUT} signal.

Voltage Regulator

Voltage regulator 110 for one embodiment, as illustrated in FIG. 1, may comprise a voltage generator 121 coupled to receive the input supply voltage V_{IN1} signal at supply node 111 and supply the output supply voltage V_{OUT} signal at output node 115. Voltage generator 121 for one embodiment may comprise a closed loop feedback control system to help supply the output supply voltage V_{OUT} signal.

Voltage generator 121 for one embodiment, as illustrated in FIG. 1, may comprise a driver 131, a variable reference signal generator 132, and an error sensor 133.

Driver 131 may be coupled to receive a supply voltage signal at supply node 111 and generate the output supply voltage V_{OUT} signal at output node 115.

Variable reference signal generator 132 may be coupled to receive a supply voltage signal at a supply node 112 and may generate a reference voltage V_{REF} signal. Supply node 112 for one embodiment may be the same as supply node 111.

Error sensor 133 may be coupled to receive the output supply voltage V_{OUT} signal at output node 115 and the reference voltage V_{REF} signal from variable reference signal generator 132 and control driver 131 based on the output supply voltage V_{OUT} signal and the reference voltage V_{REF} signal. Error sensor 133 for one embodiment may sense error in the output supply voltage V_{OUT} signal based on the reference voltage V_{REF} signal. Error sensor 133 for one embodiment may compare a voltage corresponding to the output supply voltage V_{OUT} signal to a reference voltage corresponding to the reference voltage V_{REF} signal to sense error in the output supply voltage V_{OUT} signal. Error sensor 133 for one embodiment may compare the output supply voltage V_{OUT} signal or a voltage signal derived from the output supply voltage V_{OUT} signal to the reference voltage V_{REF} signal or a voltage signal derived from the reference voltage V_{REF} signal and substantially sense the difference between such compared signals (e.g., V_{REF}−V_{OUT}) to sense error.

Error sensor 133 may be coupled to control driver 131 based on the sensed error. Error sensor 133 for one embodiment may generate one or more control signals based on the sensed error to control driver 131. Error sensor 133 for one embodiment may generate a control signal representative of the sensed error. Error sensor 133 for one embodiment may generate one or more amplified analog control signals representative of the sensed error.

Error sensor 133 for one embodiment may be coupled to control driver 131 based on the sensed error to help maintain the output supply voltage V_{OUT} signal at output node 115 at or around a suitable voltage level relative to the reference voltage V_{REF} signal despite the circuit(s) of load 106 drawing varying amounts of current from and/or supplying varying amounts of current to voltage generator 121. Error sensor 133 for one embodiment may be coupled to control driver 131 based on the sensed error to help maintain the output supply voltage V_{OUT} signal at a voltage level substantially equal to that of the reference voltage V_{REF} signal.

Error sensor 133 and driver 131 may each operate in accordance with any suitable scheme such as, for example, substantially continuously or discretely at any suitable rate.

Variable reference signal generator 132 may vary the reference voltage V_{REF} signal as error sensor 133 controls driver 131 to help control the output supply voltage V_{OUT} signal. Variable reference signal generator 132 may vary the reference voltage V_{REF} signal in any suitable manner for any suitable purpose. Variable reference signal generator 132 for one embodiment may vary the reference voltage V_{REF} signal to help prevent or reduce voltage droop at output node 115. Variable reference signal generator 132 for one embodiment may vary the reference voltage V_{REF} signal to help provide an initial boost in supplying the output supply voltage V_{OUT} signal.

Variable reference signal generator 132 for one embodiment may generate the reference voltage V_{REF} signal at a first voltage level and then at a second voltage level lower than the first voltage level. Variable reference signal generator 132 for one embodiment may generate a step voltage signal. Variable reference signal generator 132 for one embodiment may generate a pulse voltage signal.

Variable reference signal generator 132 for one embodiment may select a first one of a plurality of voltage signals as the reference voltage V_{REF} signal and may subsequently select a second one of the plurality of voltage signals as the reference voltage V_{REF} signal to vary the reference voltage V_{REF} signal.

Voltage regulator 110 for one embodiment, as illustrated in FIG. 1, may also optionally comprise a voltage generator 122 coupled to receive an input supply voltage V_{IN2} signal at a supply node 113 and supply an output supply voltage V_{OUT} signal at output node 115.

Integrated circuit 100 for one embodiment may be coupled to external power supply(ies) 102 to generate the input supply voltage V_{IN2} signal at supply node 113. The input supply voltage V_{IN2} signal at supply node 113 for one embodiment may differ from the input supply voltage V_{IN1} signal at supply node 111. The input supply voltage V_{IN2} signal at supply node 113 for one embodiment may be less than the input supply voltage V_{IN1} signal at supply node 111. Integrated circuit 100 for one embodiment may be coupled to receive different input supply voltage signals from external power supply(ies) 102. External power supply(ies) 102 for one embodiment may comprise one or more voltage regulators to help supply different input supply voltage signals. Integrated circuit 100 for one embodiment may comprise one or more voltage regulators coupled to external power supply(ies) 102 to help supply different input supply voltage signals.

Voltage regulator 110 for one embodiment may comprise a controller 123 coupled to control transitions between output voltage signals at output node 115. Controller 123 for one embodiment may be coupled to activate voltage generator 121 and deactivate voltage generator 122 to generate an output supply voltage V_{OUT} signal at output node 115 for a first mode for integrated circuit 100 and may be coupled to activate voltage generator 122 and deactivate voltage generator 121 to generate an output supply voltage V_{OUT} signal at output node 115 for a second mode for integrated circuit 100. Controller 123 for one embodiment may be coupled to switch voltage generators for a different mode in response to one or more control signals received from other circuitry of integrated circuit 100 and/or from circuitry external to integrated circuit 100.

Controller 123 for one embodiment may generate a control signal to activate or deactivate voltage generator 121. Controller 123 for one embodiment may generate a control signal to activate or deactivate voltage generator 122. Controller 123 for one embodiment may generate a single control signal to both activate voltage generator 121 and deactivate voltage generator 122 or to both deactivate voltage generator 121 and activate voltage generator 122.

Variable reference signal generator 132 for one embodiment may be coupled to vary the reference voltage V_{REF} signal as error sensor 133 controls driver 131 to help prevent or reduce voltage droop at output node 115 in transitioning between output voltage signals. Variable reference signal generator 132 for one embodiment may vary the reference voltage V_{REF} signal to help provide an initial boost in supplying the output supply voltage V_{OUT} signal by voltage generator 121 just before, as, or just after voltage regulator 122 is deactivated to help maintain the voltage level at output node 115 above a reset level. Variable reference signal generator 132 for one embodiment may therefore help prevent corrupting circuit(s) of load 106 during transitioning of output voltage signals at output node 115.

Controller 123 may control voltage generators 121 and 122 in any suitable manner to supply an output supply voltage V_{OUT} signal for any suitable mode of integrated circuit 100. Controller 123 for one embodiment may control voltage generator 122 to generate the output supply voltage V_{OUT} signal at output node 115 for the second mode to help reduce power consumption and/or power dissipation relative to having voltage generator 121 supply the output supply voltage V_{OUT} signal for the first mode. The output supply voltage V_{OUT} signal may or may not be substantially the same for the first and second modes.

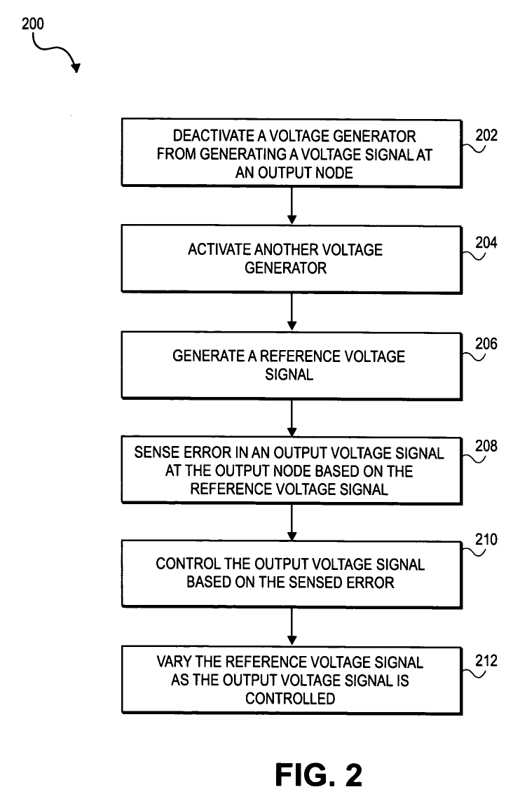

Voltage regulator 110 for one embodiment may operate in accordance with a flow diagram 200 of FIG. 2.

For block 202 of FIG. 2, controller 123 may deactivate voltage generator 122 from generating an output supply voltage V_{OUT} signal at output node 115. For block 204, controller 123 may activate voltage generator 121 to generate an output supply voltage V_{OUT} signal at output node 115.

For block 206, variable reference signal generator 132 may generate the reference voltage V_{REF} signal. For block 208, error sensor 133 may sense error in the output supply voltage V_{OUT} signal at output node 115 based on the reference voltage V_{REF} signal. For block 210, error sensor 133 may control the output supply voltage V_{OUT} signal based on the sensed error. For block 212, variable reference signal generator 132 may vary the reference voltage V_{REF} signal as the output supply voltage V_{OUT} signal is controlled.

Variable reference signal generator 132 for one embodiment for block 206 may generate the reference voltage V_{REF} signal at a first voltage level and for block 212 may vary the reference voltage V_{REF} signal to a second voltage level lower than the first voltage level.

Variable reference signal generator 132 for one embodiment for block 206 may select a first one of a plurality of voltage signals as the reference voltage V_{REF} signal and for block 212 may select a second one of the plurality of voltage signals as the reference voltage V_{REF} signal.

Voltage regulator 110 may perform operations for blocks 202-212 in any suitable order and may or may not overlap in time the performance of any suitable operation with any other suitable operation. As one example, controller 123 for one embodiment may deactivate voltage generator 122 for block 202 and activate voltage generator 121 for block 204 substantially simultaneously. As another example, error sensor 133 for one embodiment may sense error for block 208 as error sensor 133 controls the output supply voltage V_{OUT} for block 210.

Example Circuitry for Voltage Regulator

Driver 131, variable reference signal generator 132, and error sensor 133 of voltage generator 121; voltage generator 122; and controller 123 may be implemented using any suitable circuitry.

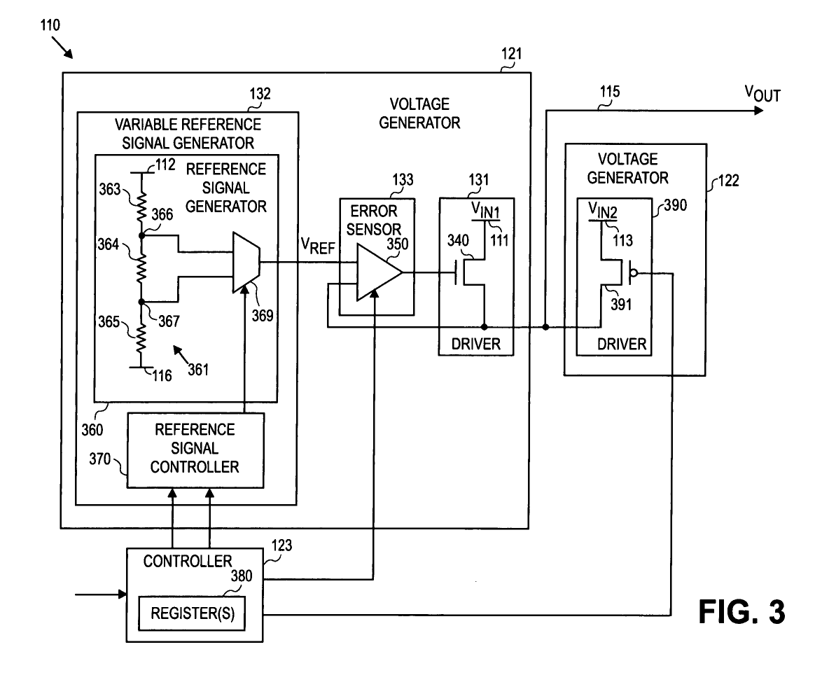

Driver 131 for one embodiment may comprise a transistor 340 coupled to couple output node 115 to supply node 111 in response to a control signal from error sensor 133. Transistor 340 for one embodiment, as illustrated in FIG. 3, may be an n-channel field effect transistor (nFET). Transistor 340 for one embodiment may be an n-channel metal oxide semiconductor field effect transistor (n-MOSFET).

Error sensor 133 of voltage generator 121 for one embodiment, as illustrated in FIG. 3, may comprise an error amplifier 350 coupled to receive the output supply voltage V_{OUT} signal at output node 115 and the reference voltage V_{REF} signal from variable reference signal generator 132 and generate a driver control signal based on the output supply voltage V_{OUT} signal and the reference voltage V_{REF} signal. Error amplifier 350 for one embodiment may generate an amplified control signal representative of error sensed in the output supply voltage V_{OUT} signal based on the reference voltage V_{REF} signal. Error amplifier 350 for one embodiment may be coupled to be activated or deactivated in response to a control signal from controller 123. Error amplifier 350 for one embodiment may comprise an operational amplifier, for example. Error amplifier 350 for one embodiment may comprise a differential error amplifier, for example.

Variable reference signal generator 132 of voltage generator 121 for one embodiment, as illustrated in FIG. 3, may comprise a reference signal generator 360 and a reference signal controller 370.

Reference signal generator 360 for one embodiment may output a selected one of a plurality of voltage signals as the reference voltage V_{REF} signal. Reference signal generator 360 may be implemented using any suitable circuitry to generate any suitable number of voltage signals at any suitable level in any suitable manner. Reference signal generator 360 for one embodiment may generate at least two voltage signals with a first voltage signal having a voltage level approximately ten percent, for example, higher than a second voltage signal.

Reference signal generator 360 for one embodiment, as illustrated in FIG. 3, may comprise a resistive network 361 to generate a plurality of voltage signals. Resistive network 361 for one embodiment, as illustrated in FIG. 3, may comprise a plurality of resistors, such as resistors 363, 364, and 365 for example, of any suitable size coupled in series between supply node 112 and a supply node 116 having a reference supply voltage signal, such as a ground signal for example, to generate voltage signals at corresponding nodes, such as nodes 366 and 367 for example. Integrated circuit 100 for one embodiment may be coupled to any suitable reference voltage supply, such as ground for example, to provide the reference supply voltage signal at supply node 116. Although illustrated as having three resistors coupled in series to define two nodes at which voltage signals may be generated, resistive network 361 may comprise any suitable number of resistors of any suitable size to generate voltage signals at any suitable number of nodes.

Reference signal generator 360 for one embodiment, as illustrated in FIG. 3, may comprise a multiplexer 369 coupled to output a selected one of a plurality of voltage signals as the reference voltage V_{REF} signal. Multiplexer 369 for one embodiment may be coupled to receive a plurality of voltage signals from resistive network 361 to output a selected one of the received voltage signals as the reference voltage V_{REF} signal. Multiplexer 369 may be implemented using any suitable circuitry, such as using a pass-gate type multiplexer, for example, to help allow analog voltage signals to pass.

Reference signal controller 370 for one embodiment may be coupled to control reference signal generator 360 as error sensor 133 controls driver 131 to select one of a plurality of voltage signals as the reference voltage V_{REF} signal. Reference signal controller 370 for one embodiment may generate one or more reference select signals to select one of a plurality of voltage signals as the reference voltage V_{REF} signal. Reference signal controller 370 for one embodiment, as illustrated in FIG. 3, may be coupled to control multiplexer 369 to select one of the voltage signals received by multiplexer 369 as the reference voltage V_{REF} signal.

Reference signal controller 370 for one embodiment may control reference signal generator 360 as error sensor 133 controls driver 131 to select a first one of a plurality of voltage signals as the reference voltage V_{REF} signal and to subsequently select a second one of the plurality of voltage signals as the reference voltage V_{REF} signal. Reference signal controller 370 for one embodiment may control reference signal generator 360 to select a first one of the plurality of voltage signals having a higher voltage level than the second one of the plurality of voltage signals.

Reference signal controller 370 may be implemented using any suitable circuitry. Reference signal controller 370 for one embodiment may comprise a pulse generator to output to reference signal generator 360 a reference select signal having a pulse of any suitable width or duration. Such a pulse generator may be implemented using any suitable circuitry, such as using logic gates with combinational delay for example.

Reference signal controller 370 for one embodiment may be coupled to control reference signal generator 360 in response to a control signal from controller 123. Controller 123 for one embodiment may generate a single control signal to activate both reference signal controller 370 and error sensor 133.

Controller 123 for one embodiment may be coupled to configure how reference signal controller 370 is to control reference signal generator 360. Reference signal controller 370 for one embodiment may be coupled to receive one or more configuration signals from controller 123 to configure reference signal controller 370. For one embodiment where reference signal controller 370 comprises a pulse generator, controller 123 for one embodiment may designate the width of a pulsed reference select signal that is to be generated to control reference signal generator 360. Controller 123 for one embodiment may comprise one or more registers 380 to store one or more configuration bits to identify how reference signal controller 370 is to be configured. Controller 123 for one embodiment may be programmable, allowing other circuitry of integrated circuit 100 and/or circuitry external to integrated circuit 100 to program register(s) 380.

Voltage generator 122 for one embodiment may comprise a driver 390 coupled to receive a supply voltage signal at supply node 113 and generate an output supply voltage V_{OUT} signal at output node 115. Driver 390 may be implemented using any suitable circuitry. Driver 390 for one embodiment may comprise a transistor 391 coupled to couple output node 115 to supply node 113 in response to a control signal from controller 123. Transistor 391 for one embodiment, as illustrated in FIG. 3, may be a p-channel field effect transistor (pFET). Transistor 391 for one embodiment may be a p-channel metal oxide semiconductor field effect transistor (p-MOSFET). Controller 123 for one embodiment may generate a single control signal to both activate transistor 391 and deactivate error sensor 133 or to both deactivate transistor 391 and activate error sensor 133.

Example Timing Diagram for Voltage Regulator

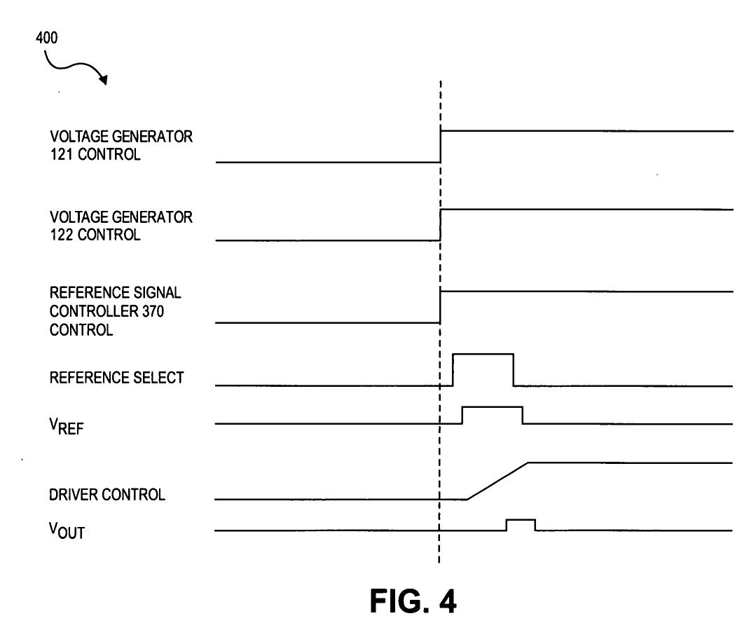

FIG. 4 illustrates, for one embodiment, an example signal timing diagram 400 for circuitry illustrated in FIG. 3. Although relatively crude, the timing diagram 400 may help illustrate how voltage regulator 110 for one embodiment may vary the reference voltage V_{REF} signal to help prevent or reduce voltage droop at output node 115, and therefore help maintain a voltage level at output node 115 above a reset level, in transitioning between output voltage signals.

As illustrated in FIGS. 3 and 4, controller 123 may generate a voltage generator 121 control signal to activate error amplifier 350, a voltage generator 122 control signal to deactivate transistor 391, and a reference signal controller 370 control signal to activate reference signal controller 370. Controller 123 for one embodiment may use a single control signal to activate error sensor 133, deactivate transistor 391, and activate reference signal controller 370.

Reference signal controller 370, in response to being activated, may generate a reference select signal having a pulse to select as the reference voltage V_{REF} signal a first, higher voltage one of a plurality of voltage signals for substantially the duration of the pulse and subsequently select as the reference voltage V_{REF} signal a second, lower voltage one of the plurality of voltage signals.

Error amplifier 350, in response to being activated, may sense error in the output supply voltage V_{OUT} signal at output node 115 relative to the reference voltage V_{REF} signal and generate a driver control signal based on the sensed error to control transistor 340 to couple output node 115 to supply node 111. Transistor 391, in response to being deactivated, may decouple output node 115 from supply node 113, allowing the output supply voltage V_{OUT} signal at output node 115 to fall. By temporarily using an initial higher reference voltage V_{REF} signal, error amplifier 350 may sense relatively greater error in the output supply voltage V_{OUT} signal and respond more quickly to drive transistor 340 to help prevent the output supply voltage V_{OUT} signal at output node 115 from falling below a reset level.

For one embodiment where voltage generator 122 may generate at output node 115 an output supply voltage V_{OUT} signal that is approximately equal to the reference voltage V_{REF} signal, error amplifier 350 may otherwise initially sense relatively small error in the output supply voltage V_{OUT} signal at output node 115 upon activation of error amplifier 350 and deactivation of transistor 391 and may therefore respond too slowly and allow the output supply voltage V_{OUT} signal to fall below a reset level. Temporarily using an initial higher reference voltage V_{REF} signal for one embodiment may help allow error amplifier 350 and/or a driver 131 that may otherwise respond too slowly to be used to help regulate the output supply voltage V_{OUT} signal. Error amplifier 350 for one embodiment may therefore be implemented without use of a high performance operational amplifier having a relatively large bandwidth and sensitivity in order to respond more quickly.

Temporarily using an initial higher reference voltage V_{REF} signal for one embodiment may also help the output supply voltage V_{OUT} signal to settle relatively faster following activation of error amplifier 350 and deactivation of transistor 391 as a relatively quicker response by error amplifier 350 may help reduce or eliminate the amount of voltage by which error amplifier 350 would have to raise the output supply voltage V_{OUT} signal following a voltage droop.

Example Application

Voltage regulator 110 for one embodiment may be used to supply a regulated output supply voltage V_{OUT} signal for use in any suitable integrated circuit for use in any suitable system. As one example, voltage regulator 110 may be used in an integrated circuit forming at least a portion of any suitable chipset for use, for example, in any suitable computer system and/or control system. As another example, voltage regulator 110 may be used in an integrated circuit forming at least a portion of any suitable processor for use, for example, in any suitable computer system and/or control system. Although illustrated in FIG. 1 as being integrated on integrated circuit 100, voltage regulator 110 for one embodiment may have only a portion integrated on a single integrated circuit.

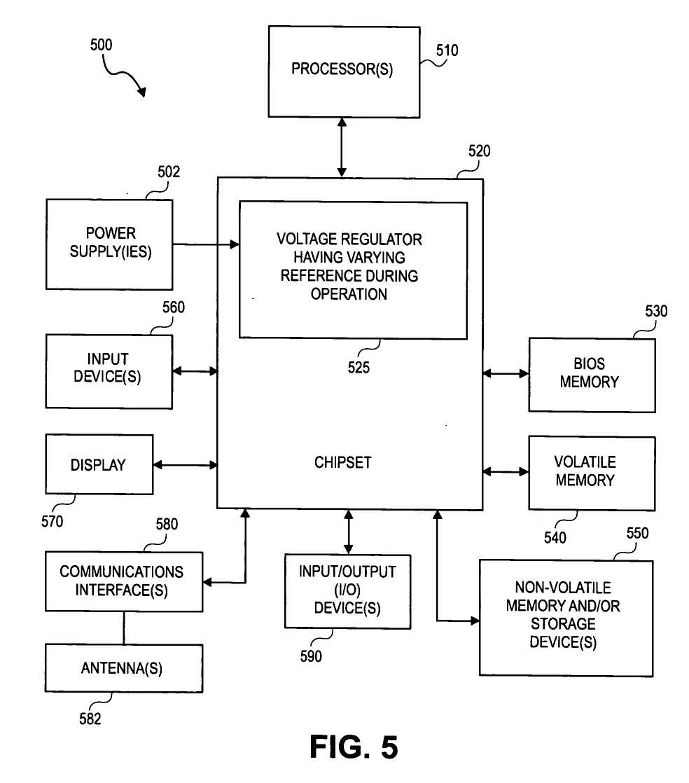

FIG. 5 illustrates, for one embodiment, an example system 500 comprising a chipset 520 having a voltage regulator 525 having a varying reference during operation and one or more power supplies 502. Chipset 520 for one embodiment may be coupled to power supply(ies) 502 to generate input supply voltage signals for voltage regulator 525. Voltage regulator 525 may be used to supply a regulated output supply voltage signal for use in any suitable one or more portions of one or more integrated circuits of chipset 520. Voltage regulator 525 and power supply(ies) 502 generally correspond to voltage regulator 110 and power supply(ies) 102 of FIG. 1.

Voltage regulator 525 for one embodiment may be used to supply a suspend supply voltage signal for use for one or more suspend and/or sleep modes for chipset 520 and may help prevent or reduce voltage droop in the suspend supply voltage signal as at least a portion of chipset 520 transitions from an active mode to a suspend or sleep mode.

System 500 for one embodiment may also comprise one or more processors 510 coupled to chipset 520, a basic input/output system (BIOS) memory 530 coupled to chipset 520, volatile memory 540 coupled to chipset 520, non-volatile memory and/or storage device(s) 550 coupled to chipset 520, one or more input devices 560 coupled to chipset 520, a display 570 coupled to chipset 520, one or more communications interfaces 580 coupled to chipset 520, and/or one or more other input/output (I/O) devices 590 coupled to chipset 520.

Chipset 520 for one embodiment may comprise any suitable interface controllers to provide for any suitable communications link to one or more processors 510 and/or to any suitable device or component in communication with chipset 520.

Chipset 520 for one embodiment may comprise a firmware controller to provide an interface to BIOS memory 530. BIOS memory 530 may be used to store any suitable system and/or video BIOS software for system 500. BIOS memory 530 may comprise any suitable non-volatile memory, such as a suitable flash memory for example. BIOS memory 530 for one embodiment may alternatively be included in chipset 520.

Chipset 520 for one embodiment may comprise one or more memory controllers to provide an interface to volatile memory 540. Voltage regulator 525 for one embodiment may be used in an integrated circuit for one or more memory controllers of chipset 520.

Volatile memory 540 may be used to load and store data and/or instructions, for example, for system 500. Volatile memory 540 may comprise any suitable volatile memory, such as suitable dynamic random access memory (DRAM) for example.

Chipset 520 for one embodiment may comprise a graphics controller to provide an interface to display 570. Display 570 may comprise any suitable display, such as a cathode ray tube (CRT) or a liquid crystal display (LCD) for example. The graphics controller for one embodiment may alternatively be external to chipset 520.

Chipset 520 for one embodiment may comprise one or more input/output (I/O) controllers to provide an interface to non-volatile memory and/or storage device(s) 550, input device(s) 560, communications interface(s) 580, and/or I/O devices 590. Voltage regulator 525 for one embodiment may be used in an integrated circuit for one or more I/O controllers of chipset 520.

Non-volatile memory and/or storage device(s) 550 may be used to store data and/or instructions, for example. Non-volatile memory and/or storage device(s) 550 may comprise any suitable non-volatile memory, such as flash memory for example, and/or may comprise any suitable non-volatile storage device(s), such as one or more hard disk drives (HDDs), one or more compact disc (CD) drives, and/or one or more digital versatile disc (DVD) drives for example.

Input device(s) 560 may comprise any suitable input device(s), such as a keyboard, a mouse, and/or any other suitable cursor control device.

Communications interface(s) 580 may provide an interface for system 500 to communicate over one or more networks and/or with any other suitable device. Communications interface(s) 580 may comprise any suitable hardware and/or firmware. Communications interface(s) 580 for one embodiment may comprise, for example, a network adapter, a wireless network adapter, a telephone modem, and/or a wireless modem. For wireless communications, communications interface(s) 580 for one embodiment may use one or more antennas 582.

I/O device(s) 590 may comprise any suitable I/O device(s) such as, for example, an audio device to help convert sound into corresponding digital signals and/or to help convert digital signals into corresponding sound, a camera, a camcorder, a printer, and/or a scanner.

Although described as residing in chipset 520, one or more controllers of chipset 520 may be integrated with one or more processors 510, allowing a processor 510 to communicate with one or more devices or components directly. As one example, a memory controller for one embodiment may be integrated with a processor 510, allowing that processor 510 to communicate with volatile memory 540 directly.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
a driver to generate an output voltage signal at an output node;
an error sensor to sense error in the output voltage signal based on a reference voltage signal and to control the driver based on the sensed error; and
a variable reference signal generator to generate the reference voltage signal and to vary the reference voltage signal as the error sensor controls the driver.

2. The apparatus of claim 1, wherein the variable reference signal generator is to generate the reference voltage signal at a first voltage level and then at a second voltage level lower than the first voltage level.

3. The apparatus of claim 1, wherein the variable reference signal generator is to generate a step voltage signal.

4. The apparatus of claim 1, wherein the variable reference signal generator is to generate a pulse voltage signal.

5. The apparatus of claim 1, comprising:
a voltage generator to generate another output voltage signal at the output node; and
a controller to control transitions between output voltage signals at the output node.

6. The apparatus of claim 5, wherein the variable reference signal generator is to vary the reference voltage signal to help prevent or reduce voltage droop at the output node in transitioning between output voltage signals.

7. An apparatus comprising:
a driver to generate an output voltage signal at an output node;
an error amplifier to control the driver based on the output voltage signal and a reference voltage signal;
a reference signal generator to output a selected one of a plurality of voltage signals as the reference voltage signal; and
a reference signal controller to control the reference signal generator as the error amplifier controls the driver to select a first one of the plurality of voltage signals as the reference voltage signal and to subsequently select a second one of the plurality of voltage signals as the reference voltage signal.

8. The apparatus of claim 7, wherein the reference signal generator comprises a multiplexer to output a selected one of a plurality of voltage signals as the reference voltage signal.

9. The apparatus of claim 7, wherein the reference signal generator comprises a resistive network to generate a plurality of voltage signals.

10. The apparatus of claim 7, wherein the reference signal controller comprises a pulse generator to output a pulsed reference select signal to the reference signal generator.

11. The apparatus of claim 7, wherein the error amplifier is to generate a control signal based on the output voltage signal and the reference voltage signal, and
wherein the driver comprises a transistor to couple a supply voltage node to the output node in response to the control signal.

12. The apparatus of claim 7, comprising:
a voltage generator to generate another output voltage signal at the output node; and
a controller to control transitions between output voltage signals at the output node.

13. The apparatus of claim 12, wherein the reference signal controller is to select a first one of the plurality of voltage signals having a higher voltage level than the second one of the plurality of voltage signals to help maintain a voltage level at the output node above a reset level in transitioning between output voltage signals.

14. The apparatus of claim 12, wherein the controller is to generate a control signal to activate the voltage generator, and
wherein the voltage generator comprises a transistor to couple a supply voltage node to the output node in response to the control signal.

15. A method comprising:
generating a reference voltage signal;
sensing error in an output voltage signal at an output node based on the reference voltage signal;
controlling the output voltage signal based on the sensed error; and
varying the reference voltage signal as the output voltage signal is controlled.

16. The method of claim 15, wherein the generating comprises generating a reference voltage signal at a first voltage level, and
wherein the varying comprises varying the reference voltage signal to a second voltage level lower than the first voltage level.

17. The method of claim 15, wherein the generating comprises selecting a first one of a plurality of voltage signals as the reference voltage signal, and
wherein the varying comprises selecting a second one of the plurality of voltage signals as the reference voltage signal.

18. The method of claim 15, comprising:
activating a voltage generator to perform the generating, sensing, controlling, and varying; and
deactivating another voltage generator from generating another output voltage signal at the output node.

19. A system comprising:
a battery; and
an integrated circuit having a voltage regulator coupled to receive an input supply voltage signal from the battery to generate a regulated output supply voltage signal at an output node, the voltage regulator including a driver to generate the output supply voltage signal, an error sensor to sense error in the output supply voltage signal based on a reference voltage signal and to control the driver based on the sensed error, and a variable reference signal generator to generate the reference voltage signal and to vary the reference voltage signal as the error sensor controls the driver.

20. The system of claim 19, wherein the voltage regulator includes a voltage generator to generate another output voltage signal at the output node and a controller to control transitions between output voltage signals at the output node.

21. The system of claim 20, wherein the variable reference signal generator is to vary the reference voltage signal to help prevent or reduce voltage droop at the output node in transitioning between output voltage signals.

22. The system of claim 20, wherein the integrated circuit forms at least a portion of a chipset.
